(19) United States
(12) Patent Application Publication
(10) Pub. No.: US 2026/0147403 A1
(43) Pub. Date: May 28, 2026

(54) METHOD FOR AUTOMATIC GENERATION OF ROUTINES BASED ON USER BEHAVIOR

(71) Applicant: T-MOBILE INNOVATIONS LLC, Overland Park, KS (US)

(72) Inventor: Kirthi Arjun Pucha, Monroe, WA (US)

(21) Appl. No.: 18/957,042

(22) Filed: Nov. 22, 2024

(51) Int. Cl. G06F 3/01; G06F 3/16

(52) U.S. Cl. CPC G06F 3/011; G06F 3/017; G06F 3/16

(57) ABSTRACT

Embodiments of the present disclosure relate to systems and methods for controlling connected electronic devices by leveraging habitual user inputs, including gesture-based and verbal commands, to generate and automate routines. User inputs, such as gestures detected by sensors in wearable devices and cameras, and verbal commands captured by microphones, are processed by machine learning algorithms to recognize patterns in user behavior and predict future needs. These habitual inputs are analyzed in conjunction with historical data and environmental context to generate candidate actions or routines tailored to the user's established preferences. The system autonomously executes these actions or suggests them for user confirmation, continuously refining its predictions through reinforcement learning.

### SUMMARY

The present disclosure is directed, in part, to methods and systems for detecting and interpreting user gestures and verbal commands to establish and generate routines and commands for controlling connected electronic devices. Substantially as shown and/or described in connection with the figures, this disclosure provides mechanisms for integrating multiple data sources and employing machine learning techniques to identify habitual inputs, enabling the system to create and automate routines based on user behaviors.

According to various aspects of the technology, the disclosed methods introduce solutions to the problem of accurately interpreting habitual user inputs within a connected environment. By implementing a system capable of receiving verbal commands and detecting user gestures, the disclosed methods and systems enable the generation of routines that mirror the user's habits and preferences. These outcomes are achieved through a method that processes habitual inputs while sensors monitor user movements and interactions. The integrated data is then analyzed using machine learning algorithms to identify patterns, generate corresponding routines, and anticipate user needs, allowing the system to autonomously perform actions on connected devices or provide contextually relevant suggestions.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates an exemplary network environment in which implementations of the present disclosure may be employed;

FIG. 4 illustrates an exemplary network environment in which implementations of the present disclosure may be employed;

FIG. 5 illustrates an exemplary network environment in which implementations of the present disclosure may be employed;

FIG. 6 illustrates an exemplary network environment in which implementations of the present disclosure may be employed; and

FIG. 7 illustrates a flow diagram of an exemplary method for controlling connected electronic devices.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Modern connected electronic devices and smart home environments rely heavily on accurate and intuitive user interfaces to enhance user experience and automate device control. A critical component in enabling these interactions is the ability to detect and interpret gestures (e.g., American Sign Language gestures, gestures that may have other context in common use, or habitual user gestures) and/or verbal commands to generate and automate routines. Users of smart home systems often seek seamless and efficient control over multiple connected devices, such as lighting, heating, entertainment systems, and security features, using natural and intuitive methods of interaction that reflect their habitual behaviors.

Conventionally, achieving accurate and reliable recognition of habitual gestures, movements, and verbal commands has been challenging due to the limitations of existing sensor technologies and the complexity of integrating multiple input modalities. Traditional methods often rely on isolated systems that use generic commands and gestures, failing to recognize and leverage user-specific habits. These methods typically do not combine verbal and gesture inputs in a meaningful way, nor do they offer real-time processing and adaptive learning needed for a truly seamless experience. Additionally, current systems lack the ability to generate and automate actionable routines based on user intents across multiple devices, leading to gaps in integrated, intuitive, and responsive control of connected devices, which can result in user frustration and inefficiencies.

In contrast to conventional solutions, the present disclosure provides a method that leverages advanced machine learning algorithms and multi-sensor fusion to enhance the detection and interpretation of habitual user gestures and verbal commands. The disclosed method includes a natural language processing (NLP) module for interpreting verbal commands, and a plurality of sensors embedded in wearable devices for detecting user gestures. By integrating these inputs, the system can accurately interpret user intentions and generate corresponding routines or commands for connected devices. The system uses machine learning algorithms to not only interpret current commands and gestures but also to predict future user needs and actions. By analyzing patterns in user behavior, environmental contexts such as time of day and ambient conditions, and historical data, the system can generate preemptive suggestions or autonomously perform actions or routines on connected devices.

Accordingly, a first aspect of the present disclosure provides a method for controlling a connected device based on user inputs. The method begins with receiving a user input from one or more input devices associated with the user. The system then determines that a plurality of devices are associated with the user. Next, the system generates a candidate action to be performed by a first device of the plurality of devices, with the candidate action being based on the user input. The system then causes the first device of the plurality of devices to perform the candidate action. This process ensures that the system effectively manages and controls connected devices in a manner that is responsive to the user's input, optimizing the performance and utility of the connected devices in the user's environment.

In a second aspect of the present disclosure, a method for controlling a connected device is provided. This method comprises a sequence of steps designed to utilize machine learning for generating and executing candidate inputs for connected devices. The method begins with receiving a first input from an input device. The system then generates, using a machine learning model, a candidate input for a user device. The system requests user feedback for the candidate input and receives a user selection confirming that the candidate input is correct. Based on the received selection, the system causes the user device to execute the candidate input.

Another aspect of the present disclosure is directed to a non-transitory computer-readable medium having instructions stored thereon that, when executed by one or more processors, cause the system to perform a method for controlling connected devices. The method involves receiving one or more user inputs from one or more user input devices. The system then identifies a user routine to be executed on one or more connected devices based on the user inputs. After identifying the routine, the system causes the one or more connected devices to perform the user routine. This method ensures that connected devices can operate autonomously based on identified user routines, providing a personalized and efficient user experience by automating frequently performed tasks.

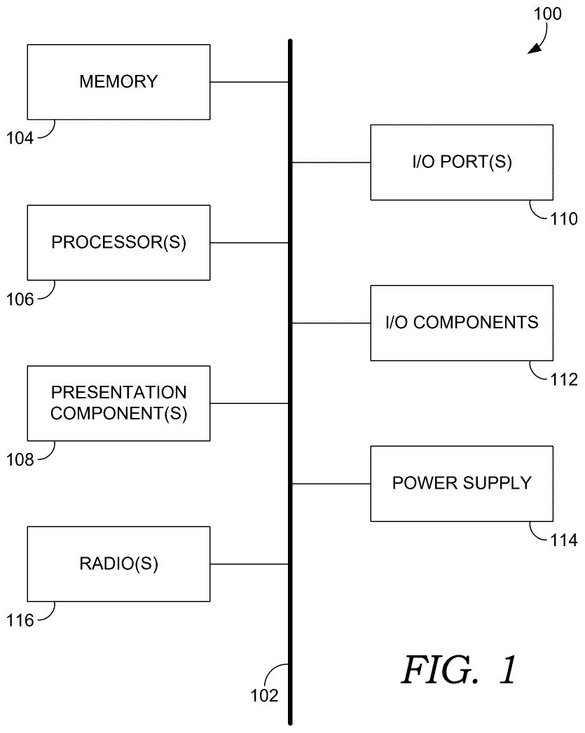

Referring to the drawings in general, and initially to FIG. 1, an exemplary computing environment 100 suitable for practicing embodiments of the present technology is provided. Computing environment 100 is just one example, and is not intended to suggest any limitation as to the scope of use or functionality of the embodiments discussed herein. Furthermore, the computing environment 100 should not be interpreted as having any dependency or requirement relating to any one or a combination of components illustrated. It should be noted that although some components in FIG. 1 are shown in the singular, they might be plural. For example, the computing environment 100 might include multiple processors and/or multiple radios. As shown in FIG. 1, computing environment 100 includes a bus 102 that directly or indirectly couples various components together, including memory 104, processor(s) 106, presentation component(s) 108 (if applicable), radio(s) 116, input/output (I/O) port(s) 110, input/output (I/O) component(s) 112, and power supply 114. More or fewer components are possible and contemplated, including in consolidated or distributed form.

Memory 104 may take the form of memory components described herein. Thus, further elaboration will not be provided here, but it should be noted that memory 104 may include any type of tangible medium that is capable of storing information, such as a database. A database may be any collection of records, data, and/or information. In one embodiment, memory 104 may include a set of embodied computer-executable instructions that, when executed, facilitate various functions or elements disclosed herein. These embodied instructions will variously be referred to as “instructions” or an “application” for short. Processor 106 may actually be multiple processors that receive instructions and process them accordingly. Presentation component 108 may include a display, a speaker, and/or other components that may present information (e.g., a display, a screen, a lamp (LED), a graphical user interface (GUI), and/or even lighted keyboards) through visual, auditory, and/or other tactile cues.

Radio 116 may facilitate communication with a network, and may additionally or alternatively facilitate other types of wireless communications, such as Wi-Fi, WiMAX, LTE, and/or other VoIP communications. In various embodiments, the radio 116 may be configured to support multiple technologies, and/or multiple radios may be configured and utilized to support multiple technologies. The input/output (I/O) ports 110 may take a variety of forms. Exemplary I/O ports may include a USB jack, a stereo jack, an infrared port, a firewire port, other proprietary communications ports, and the like. Input/output (I/O) components 112 may comprise keyboards, microphones, speakers, touchscreens, and/or any other item usable to directly or indirectly input data into the computing environment 100. Power supply 114 may include batteries, fuel cells, and/or any other component that may act as a power source to supply power to the computing environment 100 or to other network components, including through one or more electrical connections or couplings. Power supply 114 may be configured to selectively supply power to different components independently and/or concurrently.

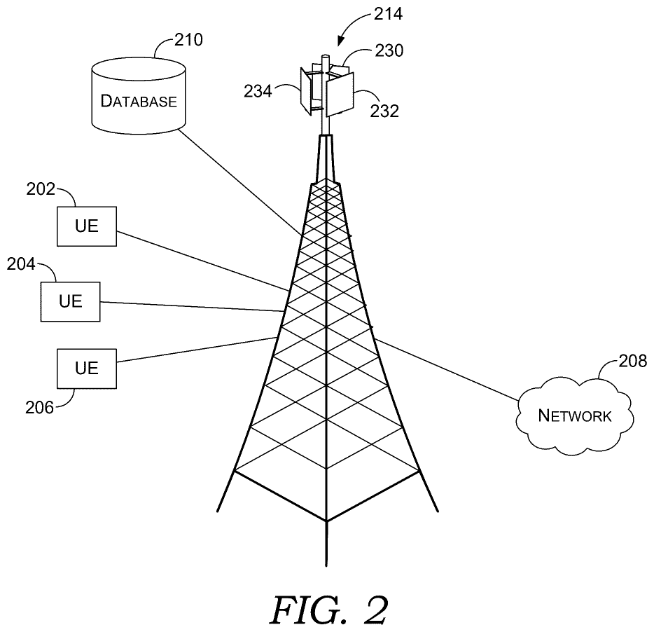

FIG. 2 provides an exemplary network environment in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 includes one or more user devices (e.g., user devices 202, 204, and 206), cell site 214, network 208, database 210, and dynamic mitigation engine 212. In network environment 200, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, an access point, and any combination of these delineated devices, or any other device that communicates via wireless communications with a cell site 214 in order to interact with a public or private network.

In some aspects, the user devices 202, 204, and 206 correspond to computing device 100 in FIG. 1. Thus, a user device may include, for example, a display(s), a power source(s) (e.g., a battery), a data store(s), a speaker(s), memory, a buffer(s), a radio(s) and the like. In some implementations, the user devices 202, 204, and 206 comprises a wireless or mobile device with which a wireless telecommunication network(s) may be utilized for communication (e.g., voice and/or data communication). In this regard, the user device may be any mobile computing device that communicates by way of a wireless network, for example, a 3G, 4G, 5G, LTE, 6G, CDMA, or any other type of network.

In In other aspects, the user devices 202, 204, and 206 encompass a diverse range of high-throughput and high data consumption devices, catering to various user needs and environments. The first device, user device 202, corresponds to a Home Internet Network Terminal (HINT). Device 204 represents a Fixed Wireless Access (FWA) device, which provides internet access in areas where wired connectivity is limited or unavailable.

Additionally, device 206 can be any device characterized by high data throughput needs, such as advanced gaming consoles that require rapid data exchange for real-time multiplayer experiences, or professional-grade video conferencing systems used in businesses for high-quality virtual meetings. This category also includes emerging Internet of Things (IOT) devices, like intelligent security cameras and smart home appliances, which constantly transmit and receive data for automation and monitoring purposes. Furthermore, high-performance tablets and laptops also fall under this category, as they require high-speed internet for cloud computing and large file transfers.

In some cases, the user devices 202, 204, and 206 in network environment 200 may optionally utilize network 208 to communicate with other computing devices (e.g., a mobile device(s), a server(s), a personal computer(s), etc.) through cell site 214. The network 208 may be a telecommunications network(s), or a portion thereof. A telecommunications network might include an array of devices or components (e.g., one or more base stations), some of which are not shown. Those devices or components may form network environments similar to what is shown in FIG. 2, and may also perform methods in accordance with the present disclosure. Components such as terminals, links, and nodes (as well as other components) may provide connectivity in various implementations. Network 208 may include multiple networks, as well as being a network of networks, but is shown in more simple form so as to not obscure other aspects of the present disclosure.

Furthermore, network environment 200 supports advanced human-device interaction mechanisms. For example, any of all of the user devices 202, 204, and 206 can be wearable devices within the network 208. These can be devices such as smartwatches or augmented reality (AR) headsets. Each of the user devices can detect user movement such as hand and finger movements through integrated sensors in the wearable device. The user devices 202, 204, and 206 can also capture gestures using embedded cameras. Additionally, user devices 202, 204, and 206 can be cameras, motion detectors, or other environmental sensors within a room, home, or environment where the user is located or near. AI-driven algorithms to recognize specific commands, which are then translated into actionable instructions for various connected electronic devices that can be user devices 202, 204, and 206, analyze the gestures and motions.

Network 208 may be part of a telecommunication network that connects subscribers to their service provider. In aspects, the service provider may be a telecommunications service provider, an internet service provider, or any other similar service provider that provides at least one of voice telecommunications and data services to any or all of the user devices 202, 204, and 206. For example, network 208 may be associated with a telecommunications provider that provides services (e.g., LTE, 4G, 5G, 6G) to the user devices 202, 204, and 206. Additionally or alternatively, network 208 may provide voice, SMS, and/or data services to user devices or corresponding users that are registered or subscribed to utilize the services provided by a telecommunications provider. Network 208 may comprise any communication network providing voice, SMS, and/or data service(s), using any one or more communication protocols, such as a 1x circuit voice, a 3G network (e.g., CDMA, CDMA2000, WCDMA, GSM, UMTS), a 4G network (WiMAX, LTE, HSDPA), a 5G network, or a 6G network. The network 208 may also be, in whole or in part, or have characteristics of, a self-optimizing network.

In some implementations, cell site 214 is configured to communicate with the user devices 202, 204, and 206 that are located within the geographical area defined by a transmission range and/or receiving range of the radio antennas of cell site 214. The geographical area may be referred to as the “coverage area” of the cell site or simply the “cell,” as used interchangeably hereinafter. Cell site 214 may include one or more base stations, base transmitter stations, radios, antennas, antenna arrays, power amplifiers, transmitters/receivers, digital signal processors, control electronics, GPS equipment, and the like. In particular, cell site 214 may be configured to wirelessly communicate with devices within a defined and limited coverage area. In an exemplary aspect, the cell site 214 comprises a base station that serves at least one sector of the cell associated with the cell site 214, and at least one transmit antenna for propagating a signal from the base station to one or more of the user devices 202, 204, and 206. In other aspects, the cell site 214 may comprise multiple base stations and/or multiple transmit antennas for each of the one or more base stations, any one or more of which may serve at least a portion of the cell. For example, the cell site may comprise a first antenna array 230, a second antenna array 232, and a third antenna array 234, wherein each of the antenna arrays serves a distinct sector (i.e., portion) of the coverage area of the cell site 214. In some aspects, the cell site 214 may comprise one or more macro cells (providing wireless coverage for users within a large geographic area) or it may be a small cell (providing wireless coverage for users within a small geographic area).

Furthermore, network environment 200 supports advanced human-device interaction mechanisms. For example, wearable devices within the network, such as smartwatches or augmented reality (AR) headsets, can detect hand and finger movements through integrated sensors and capture gestures using embedded cameras. These gestures are analyzed by AI-driven algorithms to recognize specific commands, which are then translated into actionable instructions for various connected electronic devices. This enables seamless control of devices such as smart home systems, entertainment systems, and personal computing devices.

One of the user devices, specifically user device 202, may function as a centralized hub. This hub is designed to connect and manage a plurality of smart devices within a household, including but not limited to lighting systems, thermostats, security cameras, door locks, home entertainment systems, kitchen appliances, and other IoT devices. The hub serves as the central point of control and coordination, allowing users to interact with and manage these devices through a unified interface. The hub can communicate with these devices using various wireless communication protocols such as Wi-Fi, Zigbee, Z-Wave, Bluetooth, cellular (e.g., 4G, 5G, 6G), near field communication (NFC), and other wireless or wired protocols that implementers find suitable for exchanging data between the hub and other devices.

The centralized hub leverages the advanced human-device interaction capabilities described earlier. By integrating gesture recognition and natural language processing, the hub allows users to control their smart home devices through intuitive commands. For instance, a user can adjust the lighting in a room by simply waving their hand or issue a verbal command to lock the doors. The AI-driven algorithms within the hub continuously learn from the user's behavior patterns and environmental contexts, enabling the system to anticipate user needs and make preemptive adjustments. For example, the hub might automatically dim the lights and lower the thermostat when it recognizes that the user typically prefers a more relaxed environment in the evening. In aspects, the gesture recognition may be configured to recognize and translate standardized sign language gestures (e.g., American Sign Language (ASL)) into computer-executable commands or inputs; in other aspects, the gesture recognition may be configured to learn/create an index of user-specific gestures that equate to computer-executable commands.

Additionally, the hub can function as a mediator between different devices, ensuring seamless interoperability and coordination. It can receive data from various sensors and devices, process this data to determine the appropriate actions, and then relay commands to the relevant devices. For example, if a security camera detects motion outside the house, the hub can turn on the exterior lights, lock the doors, and send a notification to the user's smartphone. The hub can also integrate with external services such as weather forecasts and energy management systems to optimize the operation of home devices. For instance, it might adjust the heating schedule based on weather predictions or manage the use of high-energy appliances to coincide with off-peak electricity rates.

In some implementations, the hub also includes a user-friendly interface accessible via a dedicated touchscreen panel, a smartphone app, or a web portal. This interface allows users to configure and monitor their smart home system, set up automation routines, and receive real-time alerts and notifications. The interface may also provide insights and recommendations based on the data collected from the connected devices, helping users to make informed decisions about their home management. Overall, the centralized hub enhances the convenience, security, and efficiency of smart home systems by providing a comprehensive and integrated control solution.

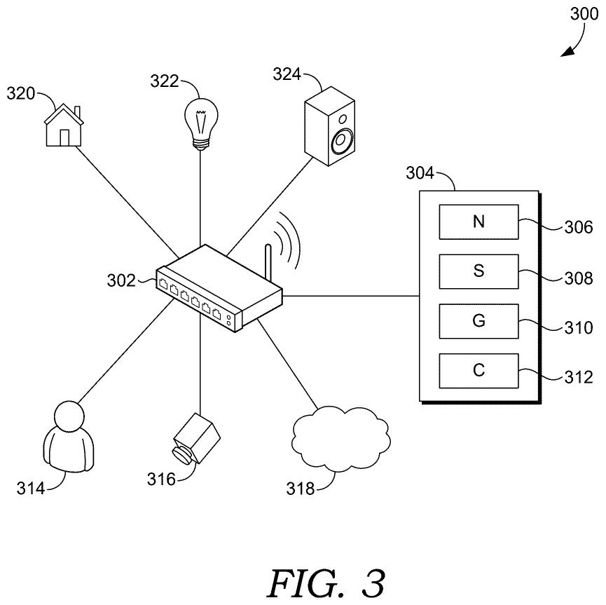

FIG. 3 illustrates an exemplary network environment 300 in which various implementations of the present disclosure may be employed. Network environment 300 is a representative example and should not be construed as limiting the scope of use or functionality of the invention. The network environment 300 includes various components that interact to control connected devices based on user inputs and automated routines derived from these inputs.

Network environment 300 includes a UE 302, which, in some embodiments, may function as a home automation hub or similar device capable of interfacing with and controlling other connected devices such as smart lights, thermostats, security systems, and various IoT devices within the environment. The UE 302 hosts a processing module 304 that comprises several sub-modules, including a natural language processing (NLP) module 306, a sensor module 308, a gesture recognition module 310, and a command execution module 312.

The NLP module 306 is configured to receive and process verbal commands issued by a user, such as person 314, through one or more microphones integrated within the UE 302 or connected devices like smart speakers 324. Upon receiving an audio input, the NLP module 306 can use automatic speech recognition (ASR) algorithms to convert the spoken language into a textual format. This conversion process involves multiple stages, including the segmentation of the audio signal into phonemes, the identification of words, and the assembly of these words into coherent text based on linguistic models.

Once the spoken language is transcribed into text, a natural language understanding (NLU) component of the NLP module 306 uses a combination of syntax parsing, semantic analysis, and context evaluation to identify the user's intent for the text. Syntax parsing involves analyzing the grammatical structure of the sentence, breaking it down into its constituent parts (such as subjects, verbs, and objects) to understand the basic structure of the command. Semantic analysis then interprets the meaning of these components within the context of the specific command. For instance, if the user says, “Turn off the lights in the living room,” the NLU module identifies “turn off” as the action, “lights” as the object, and “living room” as the location. This analysis also involves recognizing synonyms, idiomatic expressions, and variations in phrasing to ensure that the system accurately understands a wide range of commands.

In addition to syntax and semantics, the NLP module 306 also evaluates the context in which the command is given. This context can include factors such as the time of day, the user's location, previous commands given by the user, and the current state of connected devices. For example, if the user says, “Set the temperature to comfortable,” the NLU module may refer to the user's historical preferences for what constitutes a “comfortable” temperature, adjusting the thermostat accordingly.

To further refine intent detection, the NLP module 306 may incorporate machine learning models trained on large datasets of user commands and interactions. These models help the system learn from past interactions, improving its ability to predict the user's intent even in cases where the command is ambiguous or incomplete. For instance, if the user frequently says “play my favorite song” in the evenings, the system learns to associate this command with a specific playlist and time of day. The NLP module generate voice command data based on the intent of the user. The voice command data comprises data communicating the intent of the user based on the voice command(s) detected. This voice command data is communicated to the gesture recognition module 308 to be combined with gestures detected to determine candidate actions and itineraries.

The sensor module 308 detects user movement and gestures through a network of sensors embedded within user devices and the surrounding environment. These sensors, which may include accelerometers, gyroscopes, magnetometers, and optical sensors, are integrated into various devices associated with person 314. The sensor module 308 leverages this diverse array of sensors to capture a wide range of motion and environmental data, providing a detailed picture of the user's physical interactions.

Optical sensors, such as those embedded in smartwatches or smart rings, detect changes in light patterns as the user moves their hand or fingers, contributing additional data on gesture dynamics. The sensor module 308 can also utilize video data captured by external devices, such as camera 316, to further detect user gestures and movements. The video data provides visual confirmation of the gestures, allowing the system to capture intricate details of hand and finger positions, which may not be fully discernible through motion sensors alone.

To interpret the diverse data streams from these plurality of sensors, the sensor module 308 employs sensor fusion algorithms. These algorithms integrate and synthesize data from multiple sensors. For instance, while an accelerometer might detect a rapid hand movement, the combined input from a gyroscope can confirm whether the movement was a swipe or a rotational gesture. Similarly, video data can validate and refine the information provided by other sensors, ensuring a comprehensive and accurate representation of the gesture.

The sensor fusion process initially preprocesses the raw data from each sensor to filter out noise and standardize the input, ensuring consistency across the different data types. The system then applies a series of algorithms to align and correlate the sensor data, identifying patterns that correspond to specific gestures. For example, a downward swipe might be recognized by correlating the accelerometer's detection of rapid downward motion with the gyroscope's measurement of a rotational tilt. Once the sensor data is processed and fused, the resulting comprehensive gesture data is transmitted to the gesture recognition module 310 for further analysis.

The gesture recognition module 310, in conjunction with the NLP module 306, applies machine learning algorithms to accurately interpret both voice command data and detected user gestures. The NLP module 306 first processes verbal commands using ASR to convert spoken language into text, followed by NLU to interpret the meaning and intent behind the words. Simultaneously, the gesture recognition module 310 processes data from various sensors, including accelerometers, gyroscopes, and cameras, to detect and analyze user movements and gestures, including according to any one or more aspects described with respect to FIG. 2.

Both the verbal command data and gesture data are then fed into a unified machine learning model that has been trained on extensive datasets comprising both voice and gesture patterns. This model integrates the two types of inputs, allowing it to understand the user's intent more comprehensively. The gesture recognition module 310 preprocesses, extracts features, and classifies the gesture data. For example, neural networks process visual data from camera 316 to extract spatial features, while recurrent neural networks (RNNs) analyze time-series data from motion sensors to capture the temporal dynamics of the gestures. Concurrently, the NLP module 306 processes the voice data, extracting semantic and contextual features that are crucial for understanding the command.

The machine learning model then combines these processed voice data and gesture data, correlating specific gestures with corresponding verbal commands to enhance accuracy. For instance, a user might say, “Turn on the lights,” while performing a pointing gesture towards a specific area. The model recognizes the verbal command through the NLP module and cross-references it with the pointing gesture detected by the gesture recognition module to determine which specific lights should be turned on. By integrating these inputs, the system can generate more accurate and contextually relevant candidate actions.

Once the verbal commands and gestures are processed and integrated, the system uses these as inputs to determine the appropriate actions to be executed by connected devices such as smart light 322, smart speaker 324, and other components within a smart home system 320. The system interprets these inputs using an analysis of contextual factors, including the specific circumstances in which the commands and gestures were issued, the user's historical preferences, and prior interactions with the system. Additionally, the system can consider external environmental factors such as time of day, user location, and ambient conditions within environment 318, as processed by the NLP module 306 and gesture recognition module 310. This approach ensures that the system's determination of user intent is both accurate and contextually appropriate, leading to the execution of candidate actions that align with the user's expectations and needs.

The system then determines corresponding actions or candidate actions uses the real-time inputs from the gesture recognition module 310 and the NLP module 306, historical data for the user, and environmental contexts such as weather, time of day, or geolocation. Initially, the system analyzes the immediate context provided by the verbal commands and gestures, considering factors such as the specific wording of the command, the type and direction of the gesture, and the environmental conditions at the time of the input. This context is then cross-referenced with historical data, including the user's past behaviors, preferences, and the outcomes of similar actions previously executed. The system also evaluates the current state of the connected devices and the environment, ensuring that the proposed actions are feasible and appropriate given the existing conditions. Machine learning models, including decision trees and neural networks, are employed to weigh these various factors and generate a set of potential candidate actions. These candidate actions are ranked based on their alignment with the user's recognized patterns and preferences, with the highest-ranked actions being selected as the corresponding candidate actions to be executed.

In an additional embodiment, the system continuously monitors and analyzes patterns in user behavior detected through the NLP module 306 and the sensor module 308. By tracking verbal commands, detected gestures, and associated environmental contexts, the system can identify repetitive patterns in the user's actions. When these patterns exceed a predetermined threshold in terms of frequency and consistency, the system classifies them as actionable routines that can be predicted and automated in the future. The use of such threshold limits ensures that only reliable and significant behavior patterns are flagged for automation. For instance, if the system observes that person 314 consistently dims smart light 322 and plays music on smart speaker 324 at the same time each evening, and this behavior surpasses the threshold, the system recognizes this as a routine and may autonomously execute these actions and other actions that are associated with this evening routine in the future without requiring further input from the user. For example, if the user is determined to say goodnight at a particular time each night, the system can determine that the user is initiating a nighttime routine and generate a candidate routine to automatically perform on the connected devices. This routine could be: dim the smart light 322, turn down a thermostat within the smart home system 320, and other actions that the user did not request. As such, the system learns user preferences for actions on some connected devices from inputs on other connected devices.

In one embodiment, once the system has determined the corresponding candidate actions or routines, it can operate in two distinct modes: autonomous execution or user confirmation. In the autonomous mode, the system proceeds to execute the highest-ranked candidate actions or routines without requiring further input from the user. This is particularly useful for well-established routines that the system has identified through consistent user behavior, such as dimming the lights and adjusting the thermostat in the evening. The system's confidence in these actions is based on the frequency and consistency of the detected patterns, as well as the alignment with historical data.

Alternatively, in the user confirmation mode, the system generates the candidate actions or routines and then prompts the user for approval before execution. This mode is especially beneficial when the system detects a new or less frequent pattern or when the user's intent might require clarification. The system presents the proposed actions through a user interface on the UE 302 or another connected device, allowing the user to approve, modify, or reject the actions or routines. If the user provides feedback-such as adjusting the proposed action or routine-the system incorporates this feedback into its learning process, refining its decision-making algorithms for future interactions. Once the user approves the candidate actions, the system executes them as intended. This dual-mode functionality ensures that the system can adapt to varying levels of user involvement, balancing automation with the need for user control and customization

The system employs reinforcement learning techniques to continuously improve its action-selection policy. This process begins with the system receiving real-time feedback from the user following the execution of certain actions. The system uses this feedback to update its internal models, adjusting the parameters that govern how it selects actions in response to specific inputs. During this learning process, the system analyzes the outcomes of its actions, assessing whether the chosen actions were effective or aligned with the user's preferences.

As the system encounters new situations or receives additional feedback, it refines its decision-making algorithms, gradually improving its ability to match actions to the user's habits and preferences. This ongoing optimization process involves comparing the expected outcomes of potential actions with the actual results, enabling the system to adjust its strategies accordingly. Over time, the system becomes increasingly adept at recognizing patterns in user behavior, allowing it to more accurately predict which actions the user is likely to prefer.

As a result of this reinforcement learning process, the system becomes capable of suggesting or autonomously performing actions that are more closely aligned with the user's established routines and preferences. For instance, after repeated observations and adjustments, the system might learn to automatically adjust smart light 322 to a preferred brightness level in the evening or initiate music playback on smart speaker 324 at a specific time of day, without requiring explicit instructions from the user.

The execution of candidate actions and routines begins with the command execution module 312 receiving the finalized candidate actions and routines from the gesture recognition module 310. Once received, the command execution module 312 initiates the execution sequence by first confirming the readiness and status of the target devices, such as smart light 322 and smart speaker 324. This involves querying the current state of each device to ensure that they are operational and capable of receiving the command. Upon confirmation, the module securely transmits the candidate actions or routines to the respective devices using encrypted communication protocols, ensuring that the data is transmitted without interception or corruption.

Once the candidate actions or routines are delivered, the devices acknowledge receipt and begin executing the specified actions. For example, if the actions or routines are to dim smart light 322, the module monitors the light's response to ensure the brightness level is adjusted accordingly. Similarly, if the action or routine involves playing music on speaker 324, the module tracks the playback initiation. Throughout this process, the command execution module 312 continuously monitors the status of each action, ensuring that each one is carried out as intended.

If any issues are detected, such as a failure to execute or a device malfunction, the module triggers error-handling protocols, which may include retrying the action, switching to a backup action, or alerting the user to the issue. After successful execution, the module logs the completion of the action, updating the system records to reflect the current state of the devices and providing an audit trail for future reference. This comprehensive approach ensures that all actions within the network environment 300 are executed seamlessly, securely, and in alignment with the user's expectations.

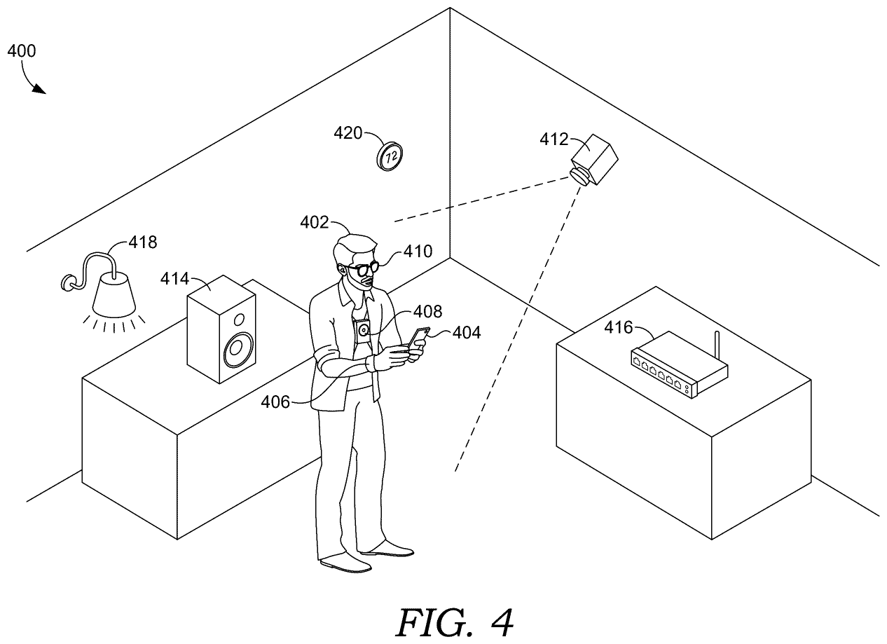

FIG. 4 illustrates an example network environment 400 in which the system described in FIG. 3 operates to detect, analyze, and respond to user gestures and verbal commands using various interconnected components. This environment demonstrates one example of a practical implementation of the system, highlighting how user inputs are processed to control connected devices. In this example environment, a user 402 interacts with the system using multiple devices. The user 402 carries a UE 404, which, in this example, is a smart phone. The user 402 wears a wearable device 406, depicted as a bracelet, equipped with multiple sensors, including accelerometers, gyroscopes, magnetometers, and optical sensors. These sensors continuously detect and transmit hand and finger movements.

Additionally, the user 402 has a personal camera 408 attached to their body, providing detailed visual data of gestures from different angles. The user 402 also wears smart glasses 410, which incorporate cameras and other sensors, offering an AR interface for real-time feedback and interaction with virtual elements. A fixed camera 412 is positioned to monitor the user 402's movements within a specific area, offering an additional perspective to enhance gesture recognition accuracy. This camera, along with the personal camera 408 and the sensors in the wearable device 406, sends data to the central hub 416, which processes and integrates this information.

The network environment 400 also supports verbal commands from the user 402. The UE 404, equipped with microphones, receives these verbal commands. The NLP module within the central hub 416 processes the audio input in real-time, converting spoken language into text data and interpreting the user's intent using techniques such as an ASR and NLU.

The connected device 414, such as smart lights or a thermostat, receives commands based on the determined gestures and verbal commands. This device is part of a broader ecosystem of IoT devices that can execute various commands, such as adjusting lighting or controlling temperature. In other embodiments, the connected device 414 can be any IoT device that is connected to the network environment 400. The central hub 416 manages data flow and processing within the environment. The central hub 416 integrates data from the various sensors, cameras, and verbal command inputs, processes it using the machine learning algorithms described in FIG. 3, and securely transmits commands to the connected devices such as connected device 414.

The network environment 400 further includes a smart light 418 and a smart thermostat 420, which are also part of the connected devices ecosystem. The smart light 418 is capable of adjusting its brightness, color, and on/off status based on user commands or automated routines. The smart thermostat 420 controls the heating and cooling of the environment, allowing for temperature adjustments that align with user preferences or routines. These devices, like the connected device 414, receive and execute commands processed by the central hub 416.

The operational process begins with a sensor within the wearable device 406 detecting hand and finger movements, and the microphones capturing verbal commands. This data is transmitted to the central hub 416 via wireless or wired connections. Simultaneously, the personal camera 408 and smart glasses 410 capture visual data of the gestures, while the fixed camera 412 monitors the overall movements of the user 402.

The gesture recognition module within the central hub 416 employs a machine learning algorithm to analyze the combined sensor, voice, and visual data. The CNN layers in the algorithm extract spatial features from the video frames, identifying key points and contours of the hand movements. Concurrently, the RNN layers process the time-series data from the sensors to capture the dynamic temporal behaviors of the gestures. The NLP module processes the verbal commands to extract meaningful instructions. The CNN layers focus on identifying shapes, edges, and movement patterns from the visual data, while the RNN layers track the sequence and rhythm of the s hypothesis via an interface on the home automation hub or smart glasses 410. The user 402 can respond with a yes or no, providing immediate feedback to refine the gesture and command library. This confirmation process involves a feedback loop where the system uses user responses to adjust its understanding and improve future predictions.

Based on the user's feedback, the machine learning model adjusts and improves its accuracy. If the gesture and command are confirmed, they are added to the personalized gesture and command library. If not, the system re-evaluates and adjusts its hypothesis. This reinforcement learning process ensures that the system becomes increasingly accurate and tailored to the user's unique gesture and command patterns. The reinforcement learning agent continuously updates its policy to optimize gesture and command recognition based on user interactions.

Once the specific gesture and verbal command are recognized and confirmed, the machine learning algorithm translates them into one or more candidate actions for the connected device 414, smart light 418, or smart thermostat 420. The command execution module within the central hub 416 securely transmits these commands using protocols such as HTTPS, MQTT, or CoAP. For example, upon recognizing the gesture and command to skip a track, the central hub 416 sends a command to the smart speaker to play the next song. The secure transmission protocols ensure that the commands are delivered reliably and without interception.

The command execution module ensures the commands are executed correctly on the connected devices, incorporating error-handling mechanisms to detect and resolve any issues during transmission and execution. Real-time feedback is provided to the user 402 through the smart glasses 410, confirming that the gesture and command have been recognized and the action executed. This feedback can be in the form of visual notifications, audio cues, or haptic vibrations, ensuring the user is aware of the system's response.

The central hub 416 also manages continuous learning and updates for the machine learning model. It periodically collects new gesture and command data, fine-tuning the model to adapt to the user's unique gesture style, verbal commands, and any changes in behavior. This ongoing learning process ensures the system remains accurate and responsive over time. The model updates are performed using online learning techniques, allowing the system to incrementally improve without requiring complete retraining.

In addition to recognizing and responding to individual commands, the system also incorporates predictive modeling to identify possible or candidate routines based on patterns in user behavior. By analyzing repetitive actions-such as the user 402 consistently lowering the smart thermostat 420, dimming the smart light 418, and playing specific music on the smart speaker at the same time each evening-the system can identify a candidate routine. When the system detects that these actions exceed a predetermined threshold in frequency and consistency, it suggests automating the routine or even autonomously performs it, streamlining the user experience. For example, as the evening approaches, the system might automatically adjust the smart thermostat 420 to the preferred temperature, dim the smart light 418, and begin playing the user's favorite playlist on the smart speaker, anticipating the user's needs based on past behavior.

The system can further anticipate the user's routines. For example, the system can identify a bedtime routine by analyzing input from devices like the UE 302. For instance, as the user begins interacting with the UE 302 in the evening-such as setting an alarm, turning off the television, or engaging with a sleep-related app-the system interprets these actions as indicators that the user is preparing for bed. The system uses this input to trigger a sequence of actions aligned with the user's established bedtime routine. Recognizing these behaviors, the system autonomously lowers the smart thermostat 420 to the user's preferred nighttime temperature, ensuring a comfortable sleeping environment. Simultaneously, the system dims the smart lights 418 to a softer level, creating a relaxing atmosphere conducive to sleep. By linking the user's interactions with the UE 302 to broader household routines, the system seamlessly orchestrates various connected devices to enhance the user's evening experience, without requiring direct commands for each action.

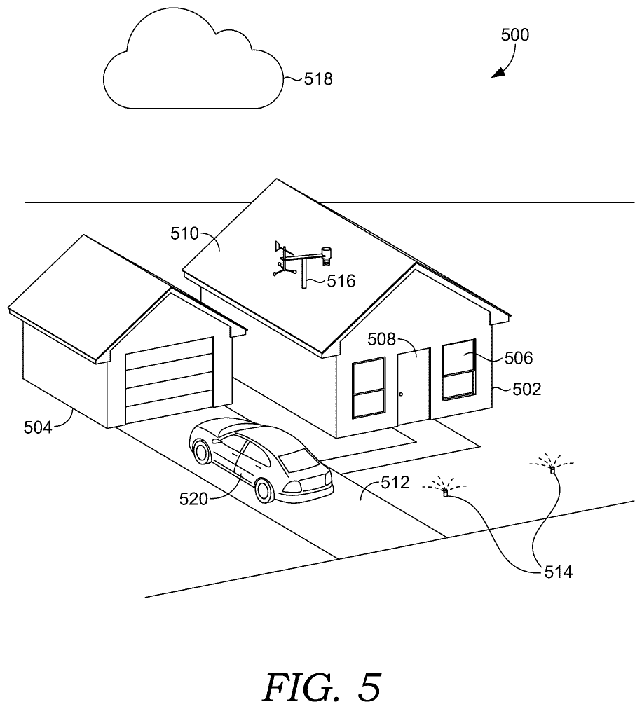

FIG. 5 illustrates an exemplary home automation environment 500, displaying various interconnected devices and systems that manage and respond to user, environmental, and weather-related data. The environment is centered around a home 502, which integrates multiple smart systems to enhance security, convenience, and energy efficiency. The home 502 can have one or more devices that operate as a home automation hub to enable the systems and methods described herein. Each of the devises described can be interconnected and communicate either wirelessly or via wired connections. This example home automation environment 500 demonstrates how these systems interact to manage the external and internal conditions of the home, based on real-time data, user interactions and gestures, and user preferences.

The home 502 includes a garage 504, which is equipped with a smart garage door opener. The smart garage door opener is capable of being controlled remotely via a user device, such as a smartphone or home automation hub. It can also be programmed to open or close based on specific triggers, such as the user approaching the garage or based on weather conditions detected by external sensors. This programming can be done using the predicted candidate actions described in FIG. 3 based on the user's actions, gestures, and historical behaviors.

The windows 506 of the home 502 are fitted with sensors that monitor their status (open or closed) and can detect breakage or forced entry. These sensors are integrated with the home's security system, allowing the homeowner to receive alerts if a window is opened unexpectedly or if an attempt to break in is detected. The sensors also provide feedback to the home automation system, which can automatically close the windows in response to certain environmental triggers, such as rain detected by the weather station 516. In one example, the system identifies a candidate action based on the user's preferences or historical actions that they close the window 506 typically when the weather station 516 detects a particular barometric pressure. In this example, the user is likely unaware they close the windows 506 when the barometric pressure drops but the system is able to identify this correlation and suggest or automatically perform a candidate action.

The door 508 is equipped with both sensors and cameras that monitor its status-whether it is open or closed-and provide visual monitoring of the entrance area. The door sensors can trigger notifications if the door is left open for an extended period or if it is opened unexpectedly. The system uses data from these sensors, combined with user behavior, to generate candidate actions. For example, if the system detects that the user frequently locks the door 508 shortly after sunset, it may identify this as a routine and generate a candidate action to automatically lock the door at this time. Additionally, the cameras provide real-time video streaming to the homeowner's device, allowing for remote monitoring. If the system detects an unauthorized person at the door based on the camera feed and user-defined security preferences, it can generate a candidate action to lock the door and activate other security measures, such as turning on exterior lights or alerting the homeowner.

The roof 510 of the home 502 is equipped with both sensors and heaters. The sensors monitor environmental conditions such as snow accumulation, ice formation, and roof temperature. Based on historical data, the system can generate candidate actions that align with the user's preferences. For instance, if the system learns that the user tends to activate the roof heaters when a specific level of snow accumulation is detected, it can suggest or automatically initiate this action when similar conditions are met. Additionally, if the system identifies that the user manually adjusts the roof heaters when the temperature drops to a particular threshold, it can generate a candidate action to automate this adjustment, ensuring that the roof remains free of excessive snow and ice without requiring user intervention.

The driveway 512 is integrated with sensors that detect various conditions, such as temperature, ice formation, and the presence of a vehicle. The system uses these sensors, combined with user behavior, to generate candidate actions. For example, if the system observes that the user often activates the driveway heaters upon returning home during winter evenings, it may generate a candidate action to automatically activate the heaters when the user's car is detected approaching the driveway under similar conditions. Furthermore, if the system notices that the garage door typically opens as the user's car approaches, it can learn this behavior and generate a candidate action to automatically open the garage door when the sensors detect the user's vehicle.

A smart sprinkler system 514 is integrated into the environment to manage the watering of the home's lawn and garden areas. This system is connected to the weather station 516, which provides real-time data on local weather conditions, such as rainfall, humidity, and temperature. The system can generate candidate actions for the sprinkler system based on the user's watering preferences and historical behavior. For example, if the system detects that the user typically postpones watering when rain is forecasted within a certain timeframe, it can generate a candidate action to automatically delay the scheduled watering based on similar weather conditions in the future. Conversely, if the system learns that the user increases watering during hot, dry spells, it can suggest or automatically adjust the watering schedule during such conditions, conserving water while maintaining the health of the lawn.

The weather station 516 collects detailed weather data around the home 502, including temperature, humidity, wind speed, and precipitation. This data is used by the smart sprinkler system 514 and is integrated into the overall home automation system to inform decisions such as when to close windows 506, activate roof heaters, or adjust the smart thermostat inside the home. In addition to the localized data provided by the weather station 516, the system also utilizes external weather data 518, which represents broader weather services or data sources. This external weather data 518 provides broader weather forecasts or warnings, allowing the home automation system to prepare for upcoming weather events by combining both local and external data inputs.

In one example of the home automation system described herein, the system uses a combination of gesture recognition, voice commands, and historical behavior patterns to automate responses during a winter storm. The user, while standing near the windows 506, gestures with an upward swipe towards the ceiling and verbally commands, “Prepare for the storm.” The system receives both the gesture and the verbal command through the integrated NLP module and gesture recognition sensors. Using historical data, the system identifies that during previous storms, the user has typically activated the roof heaters and driveway heaters. The system generates candidate actions to activate these devices, confirms these actions based on the recognized patterns, and autonomously activates the roof and driveway heaters. The system further adjusts the home's internal environment by lowering the smart thermostat 420 and closing the windows 506, actions learned from past behavior during similar weather conditions.

In another scenario, the user 506, while reviewing the day's weather on the display, says, “Cancel the watering.” Simultaneously, the user performs a downward swipe gesture. The system processes the verbal command and the gesture, cross-referencing them with past behavior patterns where the user canceled the sprinkler system 514 when rain was expected. The weather station 516 data combined with external weather data 518 confirm an incoming rainstorm, and the system generates a candidate action to cancel the sprinkler session. This action is consistent with past behavior, so the system executes it automatically, conserving water by ensuring the lawn does not receive unnecessary watering.

In a security-focused example, late at night, the user, from their bedroom, gestures with a “locking” motion towards the door 508 and commands, “Secure the house.” The system recognizes the gesture and voice command, correlating them with the user's routine of locking all entry points before going to bed. The system accesses historical data that indicates the user typically activates the security system at night. Based on this data, the system generates candidate actions to lock the door 508, close the windows 506, activate the exterior lights, and turn on the security alarm. It then executes these actions autonomously, ensuring the house is secure without further input from the user. An alert is sent to the user's smartphone, confirming that all security measures have been activated.

In another scenario, the home automation system learns a user's morning routine by monitoring inputs from various devices described in FIG. 5. Each morning, the system observes that as the user leaves the house, the smart garage door opener of the garage 504 is activated, followed by the user adjusting the smart thermostat to an energy-saving mode, and finally, the smart sprinkler system 514 is deactivated if it is an active watering day. The system detects these actions through the sensors embedded in the garage door opener of the garage 504, the smart thermostat, and the sprinkler system 514. Over time, the system identifies a consistent pattern: every weekday morning at approximately 7:00 AM, the user performs these actions in a specific sequence. Using this historical behavior data, the system generates a candidate morning routine. The next time the system detects that the user has opened the garage door of the garage 504 around 7:00 AM, it suggests automating the entire sequence: setting the smart thermostat 420 to energy-saving mode and deactivating the sprinkler system 514. The system might also close the windows 506 and lock the door 508 as part of this routine if these actions align with the user's previous behavior patterns. The user can approve this candidate routine via a voice command or a quick gesture, or the system can be set to execute the routine automatically. Over time, the system continues to refine this routine, perhaps adding new actions such as preemptively closing the windows 506 if rain is detected by the weather station 516 or turning off unnecessary lights, all based on the user's evolving morning habits.

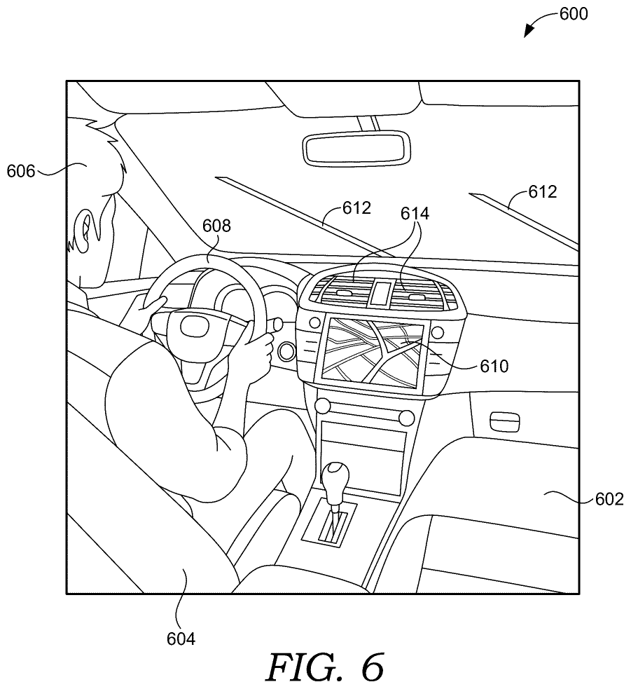

FIG. 6 illustrates an exemplary vehicle environment 600, showcasing various interconnected components within a vehicle that interact to detect and respond to the driver's actions and preferences. This environment is centered around the vehicle 600, which integrates multiple systems to enhance the driving experience through automation, safety, and comfort features. The vehicle's interior 602 is equipped with a variety of sensors and control systems that monitor the actions of the user 606, who is seated in the driver's seat 604. The driver's seat 604 can be embedded with pressure sensors and position detectors that can determine when the user 606 is seated and adjust the seat's position to match the user's preferences. These sensors also detect if the user 606 has adjusted the seat position manually, indicating a potential need to update the stored seating routine.

The driving wheel 608 is equipped with touch sensors and grip detectors that monitor how the user 606 interacts with the vehicle while driving. For example, if the user 606 grips the wheel tightly during a rainstorm, this could indicate discomfort or a need for increased safety measures. The system can detect this behavior and automatically adjust the vehicle's response, such as activating advanced traction control or modifying the vehicle's speed.

The display 610, located on the vehicle's dashboard, serves as both a feedback and control interface. It can display information related to the vehicle's status, navigation, or user preferences. The display 610 is also integrated with gesture recognition sensors and voice command systems, allowing the user 606 to control various vehicle functions without removing their hands from the driving wheel 608. For example, if the user 606 gestures towards the display 610 in a specific way, it may indicate a desire to change the climate settings or navigation route, which the system can then execute.

The windshield wipers 612 are connected to a rain detection system that monitors the intensity of precipitation on the windshield. The system can automatically adjust the speed and frequency of the windshield wipers based on this data. Additionally, the system can learn from the user's 606 manual adjustments to the windshield wipers, integrating these actions into a routine that activates during similar weather conditions.

The vehicle heating and air conditioning system 614 is responsible for maintaining the interior climate. This system is integrated with temperature sensors and air quality monitors that detect the current environmental conditions inside the vehicle. The system can automatically adjust the temperature and airflow to match the user's preferred settings, which it learns over time by monitoring manual adjustments made by the user 606. For example, if the user 606 frequently sets the air conditioning to a lower temperature when driving in the afternoon, the system can recognize this pattern and preemptively adjust the temperature before the user makes any changes.

In an exemplary embodiment, the pressure sensors in the driver's seat 604 detect that the user 606 has entered the vehicle after being outdoors in cold weather. The system recognizes this input and, based on previous patterns, knows that the user prefers a warmer cabin in these conditions. The vehicle heating and air conditioning system 614 generates a candidate action to automatically increase the temperature and direct warm air towards the user. This action is executed autonomously, providing immediate comfort without requiring manual input.

In a further embodiment, as rain begins to fall, a rain detection system activates the windshield wipers 612. The system monitors the intensity of the rain and adjusts the wiper speed accordingly. If the user 606 manually increases the wiper speed during heavy rainfall, the system records this preference as part of the user's historical behavior. The next time similar conditions are detected, the system generates a candidate action to automatically adjust the wipers to the preferred speed, enhancing the driving experience by adapting to the user's preferences.

In an additional embodiment, during a nighttime drive, the touch sensors on the driving wheel 608 detect that the user 606 has tightened their grip, which the system interprets as a sign of discomfort or heightened alertness. The system recognizes this pattern from previous night drives and generates candidate actions such as automatically activating additional safety features, including lane-keeping assistance. Additionally, the system adjusts the display 610 to reduce brightness, minimizing distractions and enhancing the user's focus. These actions are carried out autonomously, based on the recognized pattern of user behavior.

In another embodiment, while driving, the user 606 makes a specific gesture towards the display 610, which the system recognizes as a command to change the navigation route due to traffic conditions. Simultaneously, the system, using historical data, anticipates that the user prefers a cooler cabin during longer drives. It generates candidate actions to adjust the vehicle heating and air conditioning system 614 to a cooler setting. By integrating these gestures and learned behaviors into automated routines, the system enhances the driving experience, reducing the need for manual adjustments and ensuring that the vehicle environment is tailored to the user's preferences.

In another embodiment, the system monitors the user 606's daily driving habits, such as the time they leave home and the route they typically take. Over several weeks, the system detects that the user leaves the house around 7:00 AM on weekdays and drives to the same destination. Once the system determines that this routine meets a predetermined threshold of consistency (e.g., occurring on 80% of weekdays within a month), it generates a candidate routine that includes automatically setting the navigation system to the destination and adjusting the climate control to the user's preferred morning temperature. This routine is suggested to the user 606 for approval, and once confirmed, the system executes it autonomously whenever the threshold conditions are met.

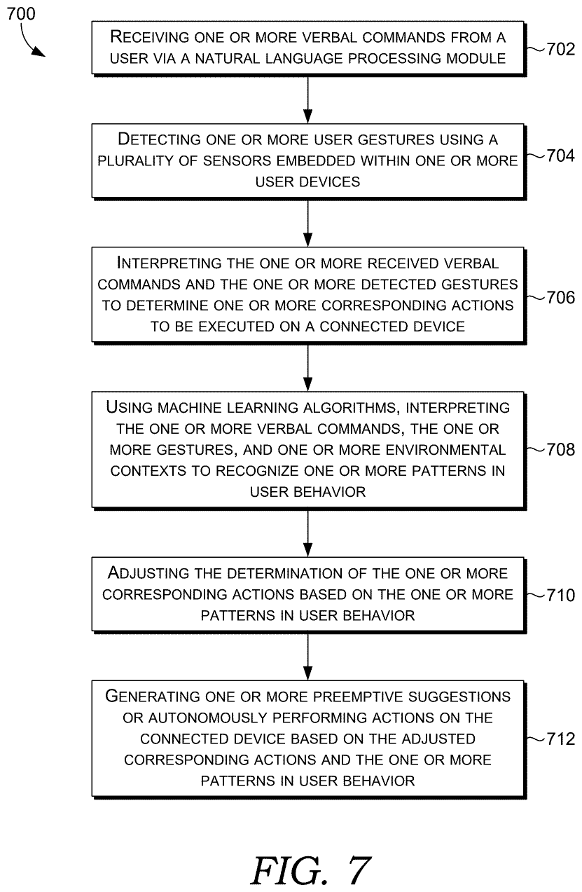

Turning now to FIG. 7, a flow chart is provided that illustrates one or more aspects of the present disclosure relating to a method 700 for controlling connected electronic devices by detecting and interpreting user inputs, including both verbal commands and gestures. The method 700 begins at block 702 with the receiving of one or more user inputs from a user via a Natural Language Processing (NLP) module. This module processes audio inputs using advanced speech recognition algorithms, converting spoken language into text and interpreting the user's intent. The NLP module utilizes techniques such as Automatic Speech Recognition (ASR) and Natural Language Understanding (NLU) to accurately transcribe and analyze the verbal commands, generating a candidate action to be performed by a connected device.

At block 704, the method involves detecting one or more user gestures using a plurality of sensors embedded within one or more user devices. These sensors can be integrated into wearable devices such as smartwatches, smart rings, or bracelets. The sensors include accelerometers, gyroscopes, magnetometers, and optical sensors, which monitor the motion and orientation of the user's hand and fingers in real-time. The sensor data is processed by the sensor module, which uses sensor fusion algorithms to create a comprehensive representation of the user's gestures. The detected gestures are then used to further refine the candidate action or generate an additional action for the connected device.

The method proceeds to block 706, where the system integrates and interprets the one or more received user inputs (verbal commands) and the one or more detected gestures to determine one or more corresponding actions to be executed on a connected device. The interpretation is facilitated by analyzing contextual information and user preferences stored in a knowledge graph. The system combines the verbal and gesture data, using machine learning models to understand the user's intent and map it to specific actions that the connected devices can perform.

At block 708, the method involves using machine learning algorithms to recognize patterns in user behavior based on the one or more verbal commands, the one or more gestures, and one or more environmental contexts. The system employs techniques such as clustering, anomaly detection, and pattern recognition to identify recurring behaviors or routines. These patterns are stored in a user profile, which the system continuously updates with new data. The machine learning models may include Convolutional Neural Networks (CNNs) for spatial feature extraction and Recurrent Neural Networks (RNNs) for temporal pattern recognition, enabling the system to recognize complex, time-dependent routines.

The method continues at block 710 with adjusting the determination of the one or more corresponding actions based on the recognized patterns in user behavior. This adjustment is performed using reinforcement learning techniques, where the system's action-selection policy is optimized based on feedback received from the user. The reinforcement learning agent learns to select actions that maximize cumulative rewards, adapting to the user's behavior and preferences over time. For example, if the system recognizes that the user frequently adjusts the smart thermostat or dims the smart lights at a specific time, it will adjust its candidate actions accordingly.

Finally, at block 712, the method involves generating one or more preemptive suggestions or autonomously performing actions on the connected devices based on the adjusted corresponding actions and the recognized patterns in user behavior. The system uses predictive modeling techniques, such as time series forecasting and decision trees, to anticipate the user's needs and generate appropriate suggestions. For instance, if the system detects a pattern where the user frequently prepares the home for bedtime by adjusting the thermostat and turning off the lights, it may suggest automating this routine or perform these actions autonomously.

In a practical example, the system combines data from the NLP module, gesture recognition module, and environmental sensors. The user 606 is observed to frequently perform a series of actions to prepare the vehicle for a drive, such as adjusting the seat and mirrors and setting the climate control. On one occasion, as the user enters the vehicle and adjusts the seat, the system predicts that the user intends to start driving. The environmental sensors confirm that the vehicle is in a typical starting condition. Based on this prediction, the system autonomously performs the following actions without further input: it starts the engine, sets the climate control to the preferred temperature, and activates the navigation system to the user's regular destination. These actions are securely transmitted to the connected devices using protocols such as HTTPS, MQTT, or CoAP. The system includes error-handling mechanisms to ensure that the commands are executed correctly and provides real-time feedback to the user 606 through devices like the vehicle's display or a smartphone interface, confirming that the vehicle is ready for the drive.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

1. A method for control of a connected device, the method comprising:
receiving a user input from one or more input devices associated with a user, the user input comprising a gesture input and a verbal input;
identifying a plurality of connected devices associated with the user;
generating a candidate routine to be performed by a first device of the plurality of connected devices, the candidate routine being based on integrating the gesture input and the verbal input, and the user input exceeding a predetermined threshold number of occurrences; and
causing the first device of the plurality of devices to perform the candidate routine.

2. The method of claim 1, wherein the user input is detected by the one or more input devices without a user request to receive the user input.

3. (canceled)

4. The method of claim 2, wherein the user input comprises at least one of a verbal command or a physical movement of the user.

5. The method of claim 4, wherein a natural language processing module uses automatic speech recognition and natural language understanding to interpret the verbal command.

6. The method of claim 1, wherein the one or more input devices comprise at least one sensor, at least one camera, or at least one microphone.

7. The method of claim 1, wherein the candidate routine is further based on one or more environmental factors.

8. The method of claim 1, wherein the one or more environmental factors include a time of day, a user location, and one or more ambient conditions.

9. The method of claim 1, further comprising receiving, from the user, an approval of the candidate routine.

10. The method of claim 1, wherein the candidate routine is generated using a machine learning model trained on a historical pattern associated with the user and the plurality of devices.

11. A method for controlling a connected device comprising:
receiving a first input from an input device, the first input comprising a gesture input and a verbal input;
generating, using a machine learning model, a candidate action for a user device based on integrating the gesture input and the verbal input;
requesting user feedback for the candidate action;
receiving a first user selection that the candidate action is correct; and
causing the user device to execute the candidate action.

12. The system of claim 11, wherein the first input is received from a sensor associated with the input device.

13. The system of claim 12, wherein the sensor comprises at least one of an accelerometer, a gyroscope, a magnetometer, or an optical sensor.

14. The system of claim 11, wherein the machine learning model is a neural network trained to predict a user preference for the user device.

15. The system of claim 11, wherein the candidate input is generated based on a combination of the first input and contextual data from a user's environment.

16. The system of claim 15, wherein the contextual data from the user's environment comprise environmental data, weather data, and time of day data.

17. The system of claim 11, further comprising generating an alternative candidate input based on receiving a second user selection that the candidate action is incorrect.

18. A non-transitory computer-readable medium storing instructions that, when executed by a processor, cause a system to perform a method for controlling a connected device, the method comprising:
receiving one or more user inputs from one or more user input devices, the one or more user inputs comprising a gesture input and a verbal input;
generating, using a machine learning algorithm, a candidate user routine to be executed on one or more connected devices based on integrating the gesture input and the verbal input; and
causing the one or more connected devices to perform the candidate user routine.

19. The non-transitory computer-readable medium of claim 18, further comprising providing a user with a summary of the candidate user routine before execution.

20. The non-transitory computer-readable medium of claim 19, further comprising receiving an indication from the user that the candidate user routine is approved.
